(19) United States
(12) Patent Application Publication
(10) Pub. No.: US 2010/0162091 A1
(43) Pub. Date: Jun. 24, 2010

(54) Methods and Apparatus for Internet Browsing and Searching Employing Geographic Location Information

(75) Inventor: Rafael Yepez, Sanford, FL (US)

Correspondence Address: PAUL W. MARTIN, NCR CORPORATION, LAW DEPT., 3097 Satellite Blvd., 2nd Floor, Duluth, GA, 30096, US

(73) Assignee: NCR Corporation, Dayton, OH (US)

(21) Appl. No.: 12/341,379

(22) Filed: Dec. 22, 2008

(51) Int. Cl. G06F 17/30; G06F 17/00; G06F 17/20; G06F 17/21

(52) U.S. Cl. 715/201

(57) ABSTRACT

Systems and techniques for managing Internet navigation and browsing results and other information using a visual geographic interface. A user interface including a map display is presented, along with interface elements for searching, browsing, and otherwise retrieving information. Results lists are compiled based on user inputs and geographic information is associated with each item in the results list. The items in the results list are presented to the user in a map display, with facilities for changing the organization and presentation of results according to user inputs including graphical inputs defining geographic areas of interest.

### FIELD OF THE INVENTION

The present invention relates generally to improvements to Internet browsing and searching. More particularly, the invention relates to improved systems and techniques for automatically identifying location information associated with browsing and search results and presenting the results on a map based on the associated location information.

### BACKGROUND OF THE INVENTION

Internet browsing and searching are conducted continually by millions of users. In a typical search, results are chosen according to some criteria calculated to rank results based on their interest to the user. This ranking may take into account numerous factors, such as the frequency with which users visit a site provided as a search result, names of sites and the estimated association of a name with a search, tags associated with a site, or the like. Such results are typically presented in a list, which may span numerous pages. Presentation of results in a list typically result in low rates of selection by users of results having low rankings, particularly if the ranking of a result does not place the result on the first page.

### SUMMARY OF THE INVENTION

The present invention recognizes that one element of interest to users in many cases is the geographic location in which a site is located or with which it is associated. Geographic location information presents an additional useful element of information and also provides a convenient format for presentation of search results. The present invention therefore provides systems and techniques for identifying the geographic location of a site, or a geographic location with which a site may conveniently be associated or to which the site is relevant. The user is provided with an interface for searching and navigation that allows visual designation of areas or locations of interest, and such designations may be used in defining desired search and navigation results, and may also be used to present and organize results once searching and navigation has been accomplished.

A user is preferably presented with search results in a visual format, for example, as markers on a map. The search results may also be presented in a list accompanying the map. The initial search, or the presentation of the results, may provide opportunities for a user to filter results by region of interest, with such filtering resulting in restriction of results to such regions of interest and consequent designation of the map area on which results are presented. Such designation may be accomplished by zooming in on the map to highlight the area of interest.

Once results have been presented, a user may obtain additional detail by making appropriate selections. For example, if an Internet site is designated by a marker on a map, a user may access a miniature presentation of the site's home page by rolling a mouse pointer over the marker, and may navigate to the site by clicking the marker.

Additional facilities may be provided to identify and highlight regions of interest, and to change the presentation of results. For example, a user may be provided facilities to draw boundaries on the map, with the redrawing of boundaries resulting in the selection and presentation of sites within the geographic area defined by the boundaries. A user may also be provided facilities to draw or plot lines from one point to another, for example, to designate an intended travel route, and the drawing or plotting of such lines may result in the presentation of results located geographically near the lines. Numerous additional mechanisms can be presented for selection and organization of results, such as defining a radius around a designated point of interest, highlighting cities, states, or countries.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a system according to an aspect of the present invention;

FIGS. 2-4 illustrate aspects of a browser interface presented by a system according to an aspect of the present invention; and

FIG. 5 illustrates a process of Internet search and navigation according to an aspect of the present invention.

### DETAILED DESCRIPTION

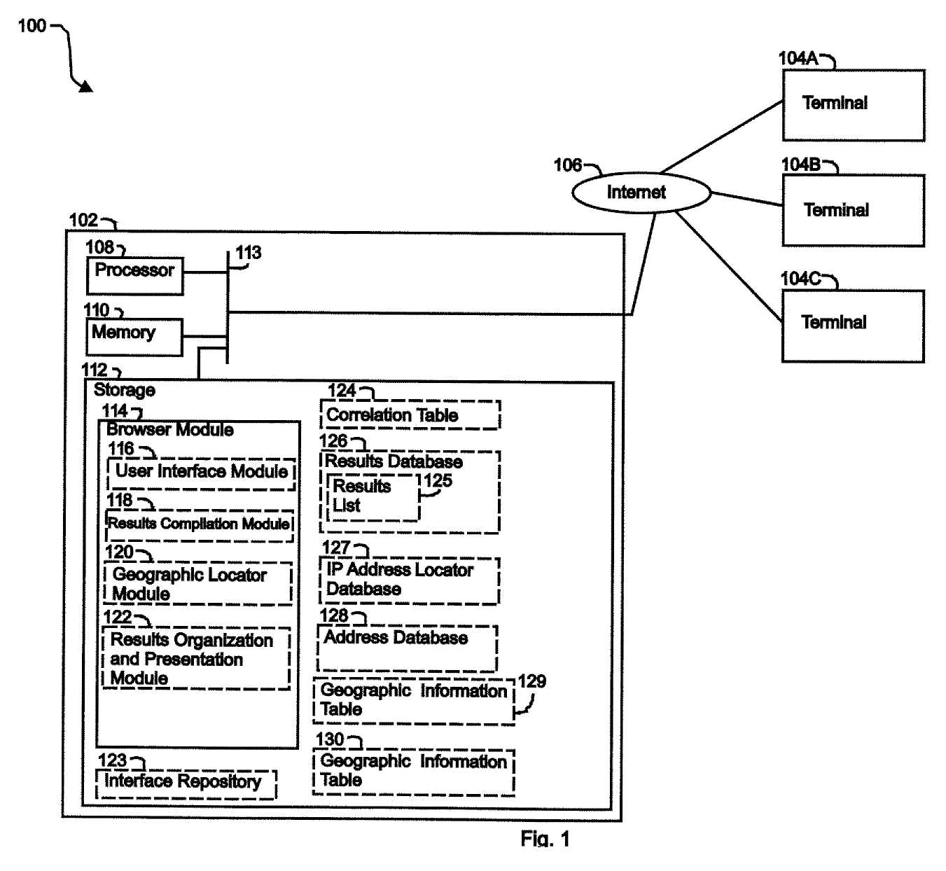

FIG. 1 illustrates a system 100 according to an aspect of the present invention. The system 100 includes a search server 102 communicating with users at terminals 104A, 104B, and 104C, for example, over the public Internet 106. The search server 102 includes a processor 108, memory 110, and storage 112, communicating over a bus 113. A single server 102 is illustrated here performing the various functions and operations needed to serve the needs of users, but it will be recognized that these functions and operations may be distributed as desired. For example, multiple servers may be used to serve numerous users, or different operations may be performed by different servers.

The server 102 implements a number of functions, suitably implemented as software in the form of program instructions stored in storage 112 and transferred to memory 110 as needed for execution by the processor 108. One such function is a browser module 114. The browser module 114 presents a browser interface to a user for receiving inputs and presenting web pages and search results. The browser module 114 manages navigation to websites and the conduct of searches based on user inputs, and organizes and presents the results of search operations.

As discussed below in greater detail, the browser interface presented by the browser module suitably includes a map display presenting an overview of a geographic area for which results are to be displayed, and also includes various tools to increase or restrict the area presented by the map and to select map regions. The browser interface may also provide various tools that may be used to execute searches and manage search results. For example, the interface may provide menus that allow selection of common search terms and may also provide fields for search terms that may be used in place of or added to, terms or expressions used in a free form search.

The browser module 114 may provide its own search capability. For example, the browser module 114 may present a form to a user for search and filtering inputs and conduct searches according to its own protocols. Alternatively, the browser module 114 may invoke third party search engines automatically or upon user navigation to those search engines. In either case, the browser module 114 may construct a search based on free form user inputs as well as any user menu selections and field entries and executes the search or submits the search to the selected search engine. The browser module 114 receives and organizes an initial set of results from the search. As described in greater detail below, results received by the browser 114 may be organized based in part on geographic location information and presented so as to provide geographic location information for the results that are retrieved.

The browser module 114 provides filter and preference selections for restricting search results. Depending on the particular implementation desired, or according to user preference selections, filter and preference selections may be incorporated into a search to influence what results are obtained, or may be applied to the results of a search once the results have been obtained in order to limit and organize the results.

The browser module 114 may suitably employ a user interface module 116, a results compilation module 118, a geographic locator module 120, and a results organization and presentation module 122.

The user interface module 116 presents the browser interface, allowing user inputs and selections and presenting results. Desired user interface elements may be drawn from an interface repository 123, which provides elements such as page structure designs, maps and drawing tools. Other elements may include sets of characteristics defining a page's overall look and feel, such as color scheme, map style, font types, font sizes, and other characteristics. A selected page structure may define the ways in which choices are to be made, such as by providing fields for free form entries for filter, search, and preference terms, by providing menu structures for selection of terms to be used to generate and organize results, and to define other page characteristics. User inputs and selections may be made through alphanumeric entries or in the form of graphical selections. For example, a user may define a geographic area of interest by zooming in a map or by drawing boundaries on the map, or by drawing a line on a map. Such a line may represent a user's planned path of travel, resulting in the selection of results along the path and within an appropriate distance.

When the user makes graphical inputs to designate geographic locations or boundaries, the interface module 116 refers to a correlation table 124, which correlates map position information with corresponding geographic location information. The user interface module 116 analyzes the user's graphical inputs to define the map positions they indicate, retrieves corresponding geographic location information from the table 124, and delivers the geographic location information indicated by the user's graphical inputs to the browser module 114. The browser module 114 uses this geographic location information in navigation and search commands.

Results generated from a search may suitably be stored in a results list such as the results list 125, suitably stored in a results database 126, and the results from a particular navigation or search action may be maintained as the results of the search or navigation are examined. The geographic locator module 120 examines results in an initial results list returned from a search and retrieves the IP address of each result. The geographic locator module 120 then consults an IP address locator database 127, which returns geographic location information for the IP address. The geographic location information may suitably be expressed in standardized terms such latitude and longitude coordinates. Geographic information associated with an IP address typically does not exactly locate the physical facility hosting the IP address, but does locate it within a relatively small geographic area. This geographic area is typically on the order of a neighborhood or section of a city.

In addition to taking geographic information from a website's IP address, it is also possible to use address information which may be provided by the owner of the website. Many website proprietors wish to promote address information in order to help potential customers to locate their facilities, and such information, if available, can precisely locate an establishment. The geographic locator module 120 may therefore consult an address database 128 that correlates address information with geographic location information. The geographic locator module 120 may use the geographic location so obtained to locate the establishment of interest.

Address information provided by a proprietor of a website or an establishment may also be correlated against geographic information provided by the website's IP address in order to identify discrepancies. For example, if a search for pet shops returns the name of a pet shop that represents its address as located in the United States, but its website is located in a country known for Internet fraud involving pets, such a discrepancy may be used to exclude the website from any search results.

The geographic locator module 120 assigns location information to each search result and furnishes this geographic location information to the results compilation module 118. The results compilation module 118 uses the geographic information, and filter and preference information, to limit and organize results, excluding results that do not fall within the categories specified by the filter and preference information, or whose geographic location places them outside the area of interest. The results compilation module 118 may, for example, create queries used to search the results list 126 for search results conforming to the query and organize those results for delivery to the user. These queries may differ from the original query used for a search. An initial search may, for example, be performed based on a wide geographic area or may be conducted without any geographic restriction. The results list produced from that search may then be filtered and organized based on subsequent user inputs and queries without a need to conduct a new search. A query may, for example, designate that only results within a particular geographic area and related to particular search terms are to be delivered. The results compilation module 118 may change and resubmit queries as the user works to redefine desired results. For example, if a user reduces the geographic area of interest by zooming the map, the results compilation module 118 may create a new query including the new geographic boundaries and submit the new query to the database 126. Similarly, if new filter terms are added, or existing filter terms are removed, new queries may be created and submitted using the new set of filter terms.

Once results have been compiled and geographic information has been added to the results, the results presentation and organization module 122 assembles the results returned by the results compilation module 118 and delivers the results to the user interface module 116 for presentation. The results presentation and organization module 122 assigns appropriate attributes, such as size, appearance, and placement attributes, to the compiled results and submits the results to the user interface module 116, and the user interface module 116 presents the results in the browser window. In one exemplary embodiment, a list of search results is presented alongside a map view with markers representing the geographic location of each search result. The selection and presentation of results is performed in accordance with the map area selected for presentation, such as a zoom level, a bounded area, or a linear pathway. Each marker represents a link to the associated website, which acts to present a preview of the website when a mouse pointer is placed on the marker, and to navigate to the website when the marker is clicked. As the user reconfigures the geographic area under consideration, search results may be rearranged, with more or fewer results being shown as an area under consideration is expanded or reduced, or with different sets of results being shown as different areas are selected. In addition, operations on the map may suitably act to alter the list of presented results.

Significant additional information may be organized and presented using geographic location information. For example, the server 102, or the user's own terminal, such as the terminal 104, may maintain a personal information database 129. For example, users frequently maintain a set of bookmarks, which include website addresses of frequently visited sites, and which may include additional description. The browser module 114 may assign geographic location information to each bookmark. Bookmarks may be presented on a map display, with a user being able to filter and organize the bookmarks as desired, in a manner similar to that described above for search results. A listing of a user's social networking friends may also be maintained, with the listing including geographic information for each member of the list, so that the list members, or a selection of the list members, may be presented on a map display.

Additional useful information may be stored in such a way as to be easily accessible using map based geographic inputs. For example, the browser module 114 may have access to a regional information database 130, which stores relevant information relating to various regions whose location can be identified by placing the mouse pointer at an appropriate location on the map. The regional information database 130 may store information of interest, such as local language for each country, statistical information for each country, state, and city, demographic information of interest, and additional relevant information, associated with geographic information indicating where such information is applicable. The browser module 114 may include settings allowing retrieval of such information by moving the mouse pointer to a location of interest and making an appropriate selection. In addition, information provided by the regional information database 130 may be used to provide information useful for additional aspects of the operation of the browser module 114. For example, the regional information database 130 may be examined to identify the local language of a location or region of interest, and an automated translator may be used to translate a list of search results for that location or region.

In addition, the user interface module 116 may present options to a user to save a results list for a particular search or presentation in a standardized file, with geographic information and display and filtering settings being included in the file so that loading the file will present the search results as they were presented when the file was saved.

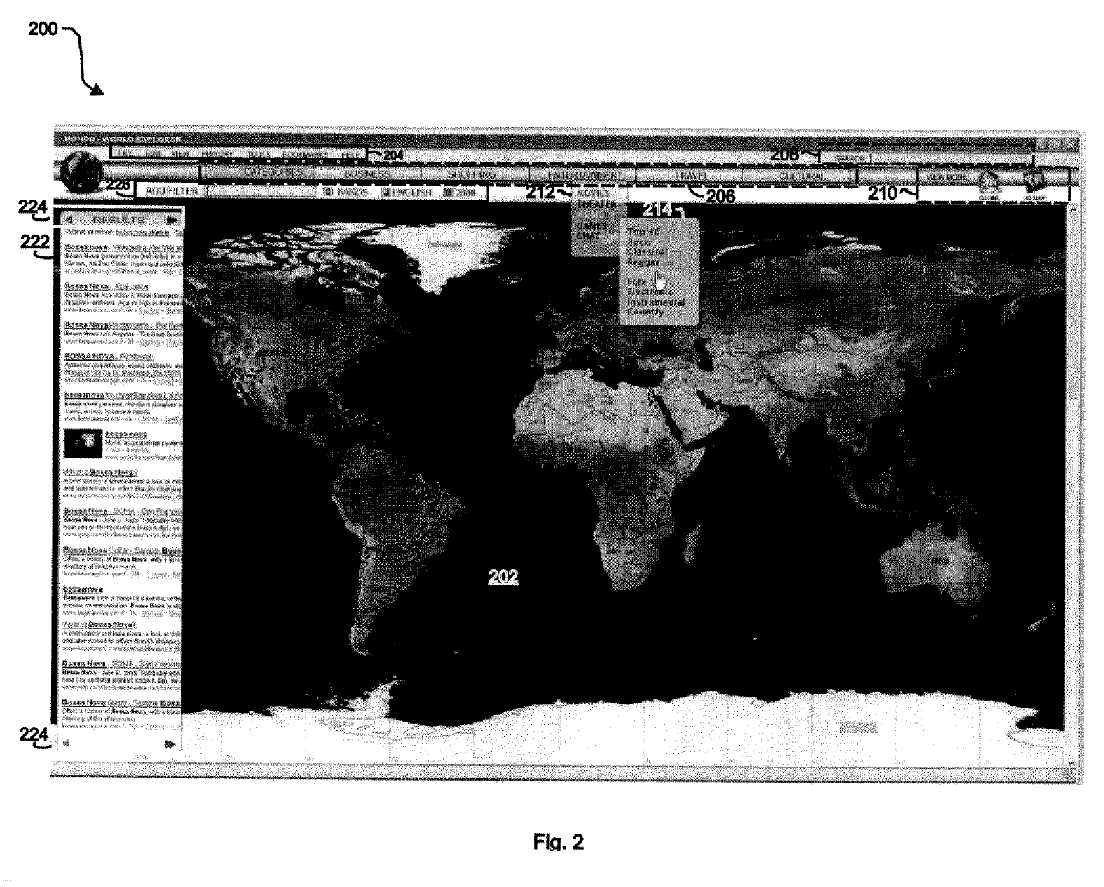

FIG. 2 illustrates a browser window 200 according to an aspect of the present invention. The browser window 200 illustrates a map 202 presenting a list of results obtained as a result of a search generated by a sequence of pulldown menu selections. The browser window 200 provides for a set 204 of pulldown menus for navigation and management, and a set 206 of search menus for selecting predefined search terms. The browser window 200 further provides a free form search field 208. The map 202 is a relief map, but any of numerous map styles may be used, such as political maps, topographical maps, street maps, and the like, with the particular map style being designated, for example, as a user interface characteristic selected for a particular browser interface. If desired, the user may be provided with selection tools to choose the particular map style to be used, and may also be provided with a view mode selection tool 210, allowing choice of a two dimensional map or a globe.

In the present example, the user has made menu selections in order to select “Entertainment,” generating the menu 212, from which the user selected “Music,” generating the menu 214, from which the user finally selected “Bossa Nova” The results compilation module 116 received the results and passed them to the geographic location module 118, which assigned geographic location indicia to each result. The results presentation module 120 then processed the results to generate a results list 222, in which the initial results are visible, with navigation areas 224 that may be used to page through results. The results presentation module 120 also populated the map 202 with indicators corresponding to geographic location of each of the search results. As the user makes selections and changes relating to presentation of the generated results, the results compilation module 118 gathers groupings of results in accordance with the changes and these results are delivered to the browser window 200.

In addition to providing mechanisms for changing the geographic extent of the desired results, the browser window 200 presents a filter toolbar 226, allowing a user to make selections and add terms to filter results. The user is able to make selections based on geographic considerations using the map 202. For example, the user may select map areas, may zoom the map in or out, and may define boundaries for areas to be considered. The user may also use the filter toolbar to enter free form filtering terms and make selections from among predefined filtering terms, terms will be used by the results compilation module 118 to identify and deliver new groupings of results.

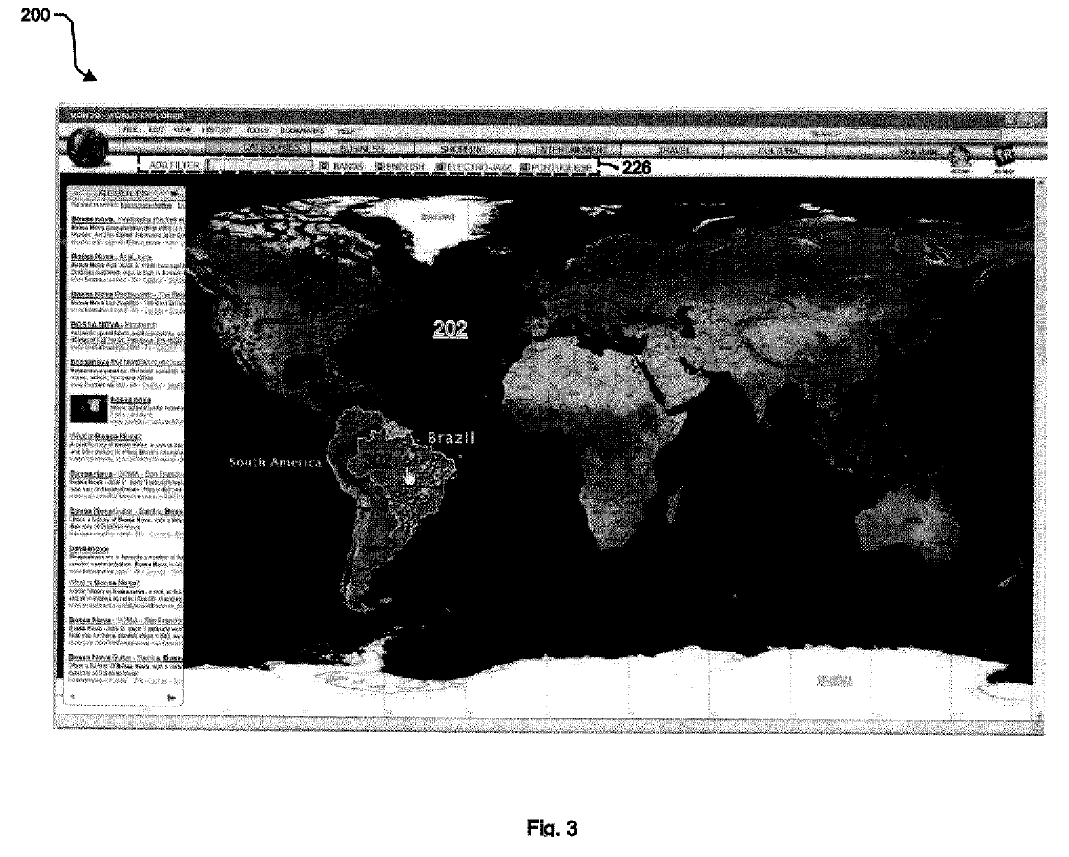

FIG. 3 illustrates the browser window 200, while the user is in the process of examining the map 202 in preparation for narrowing the geographic area of interest. The region 302, representing the country of Brazil, is highlighted, and the names of the continent and the country are also visible. In addition, the filter toolbar 226 has been changed, with one selection having been eliminated and new selections having been made available.

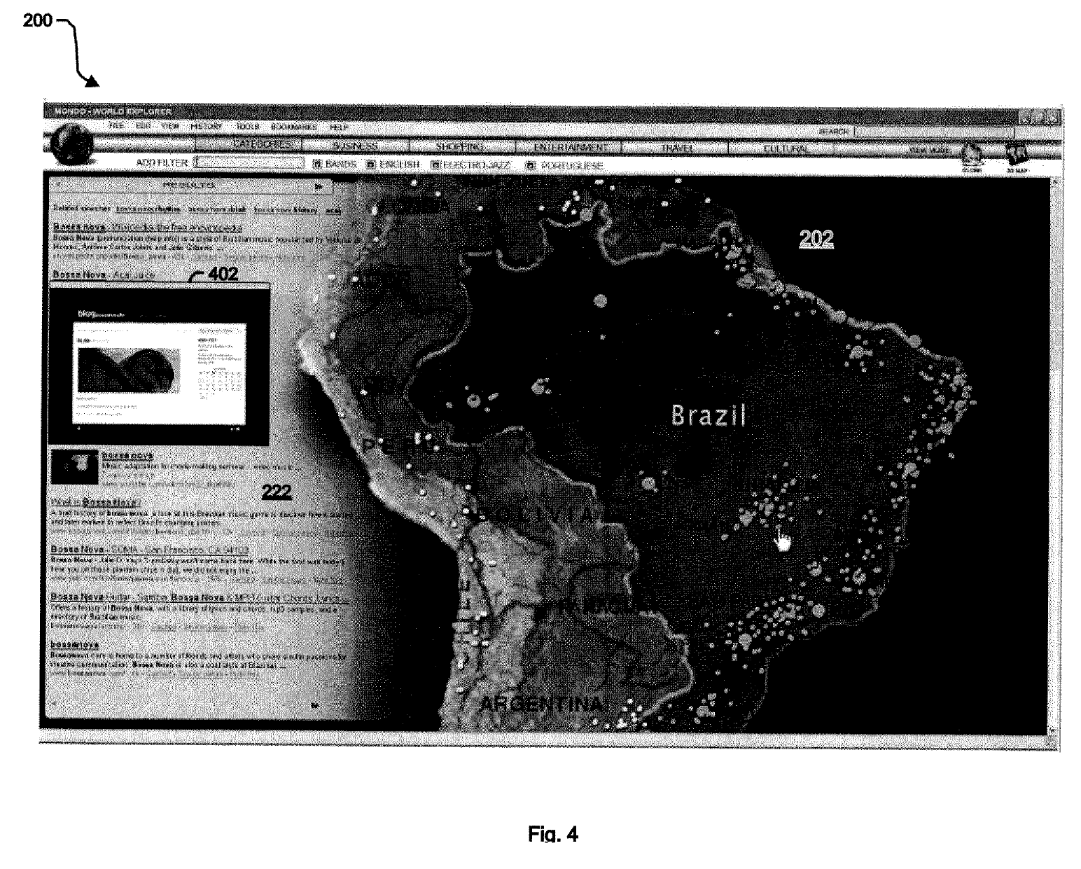

FIG. 4 illustrates the browser window 200, with the range of the map 202 narrowed to encompass a portion of South America. The region of interest has been highlighted and the search results within the area of interest are presented as highlighted markers. In addition, the user has moved the mouse pointer over the marker representing a particular search result, causing a preview window 402 to open in the results list 222.

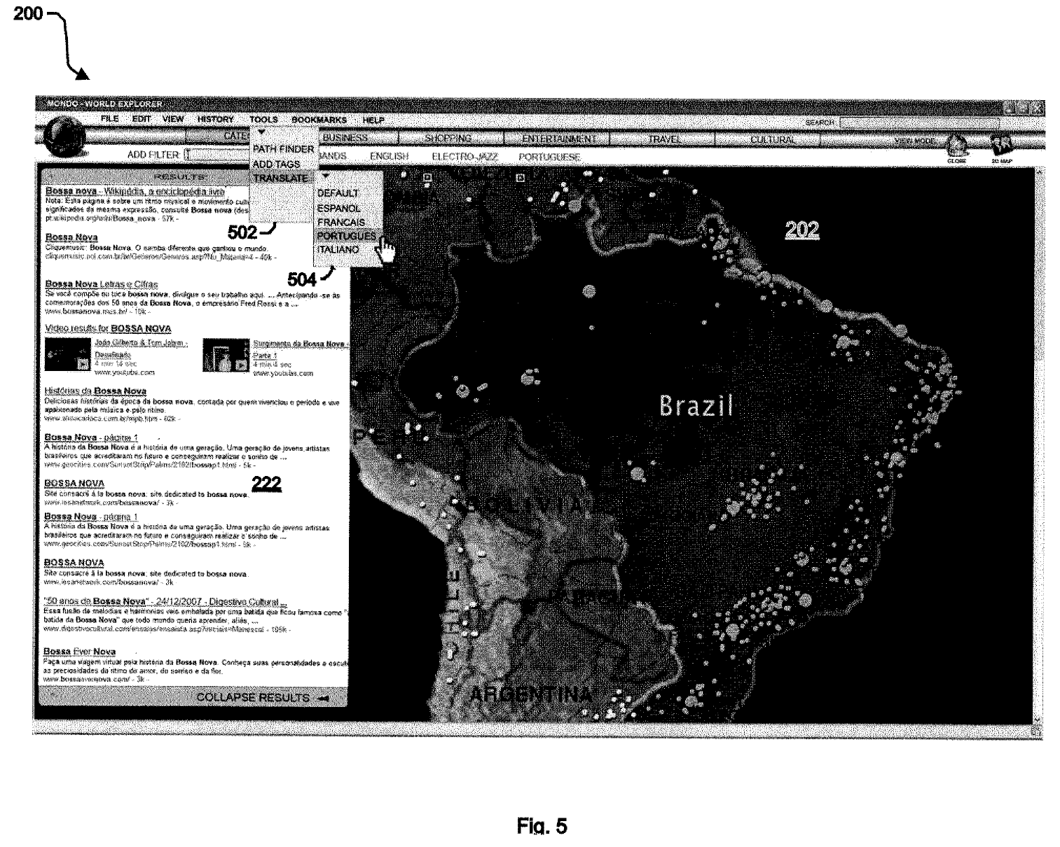

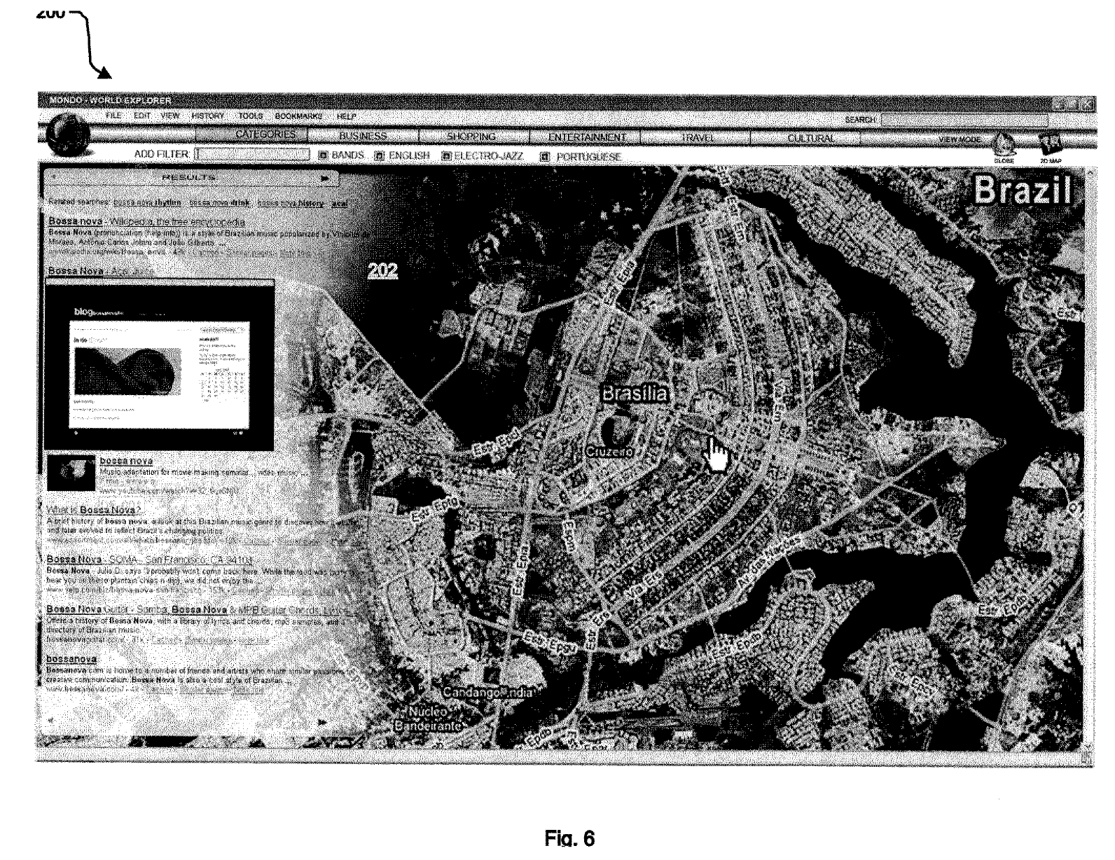

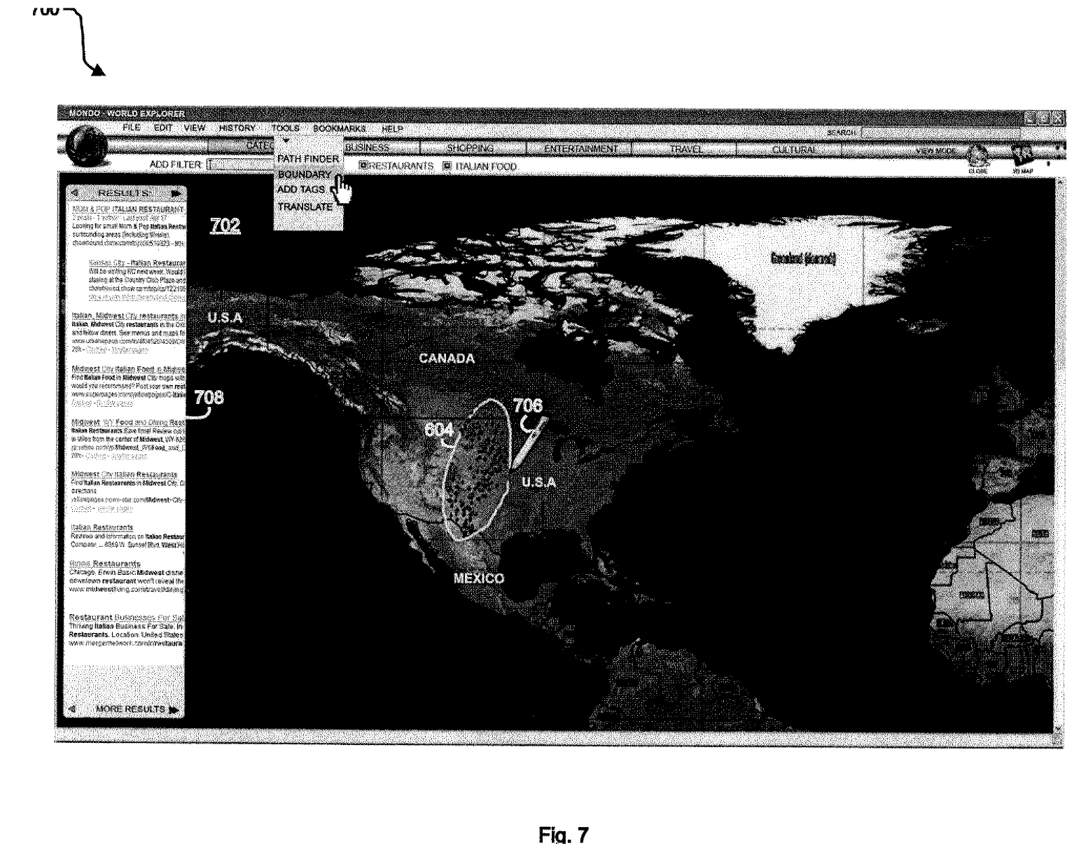

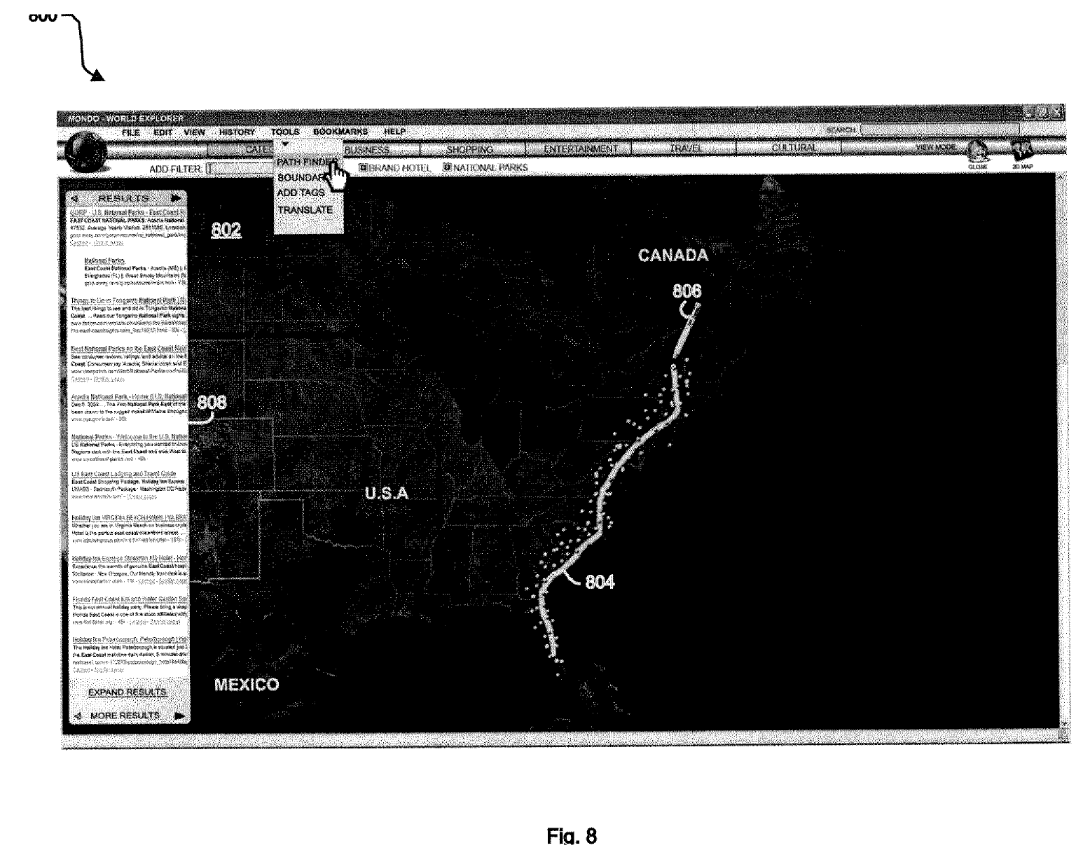

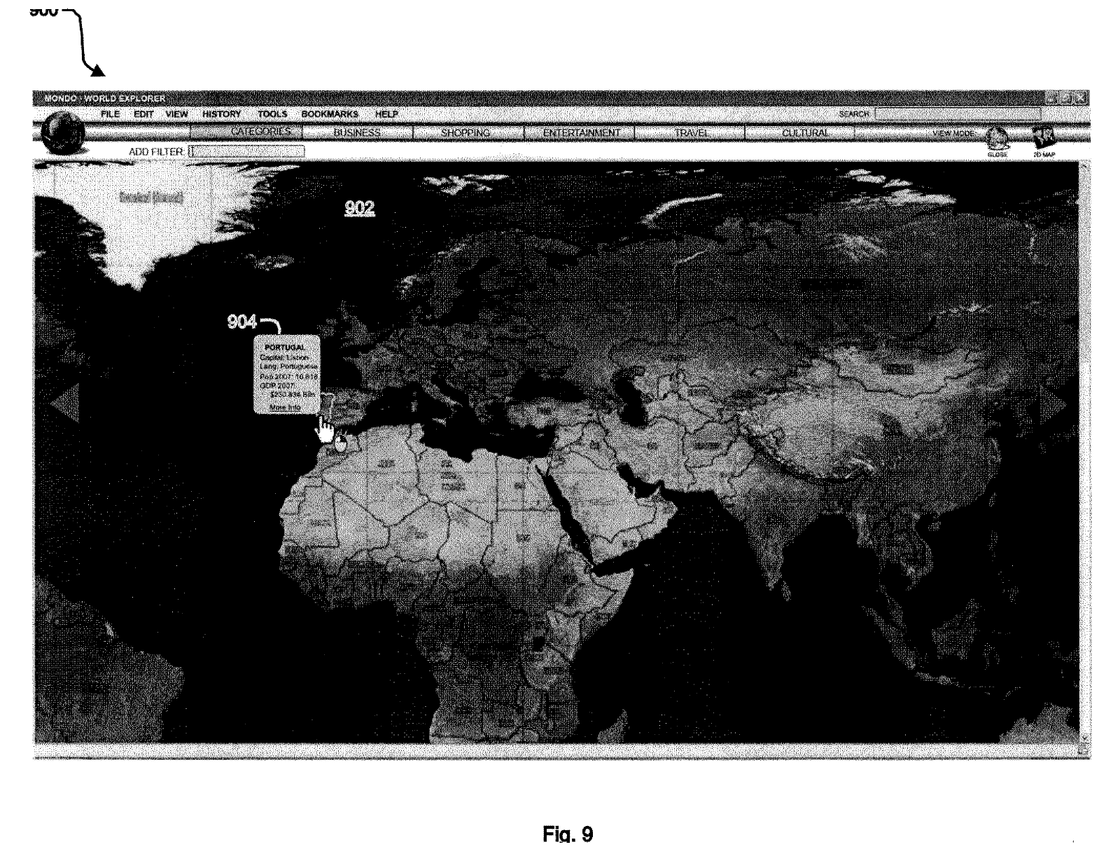

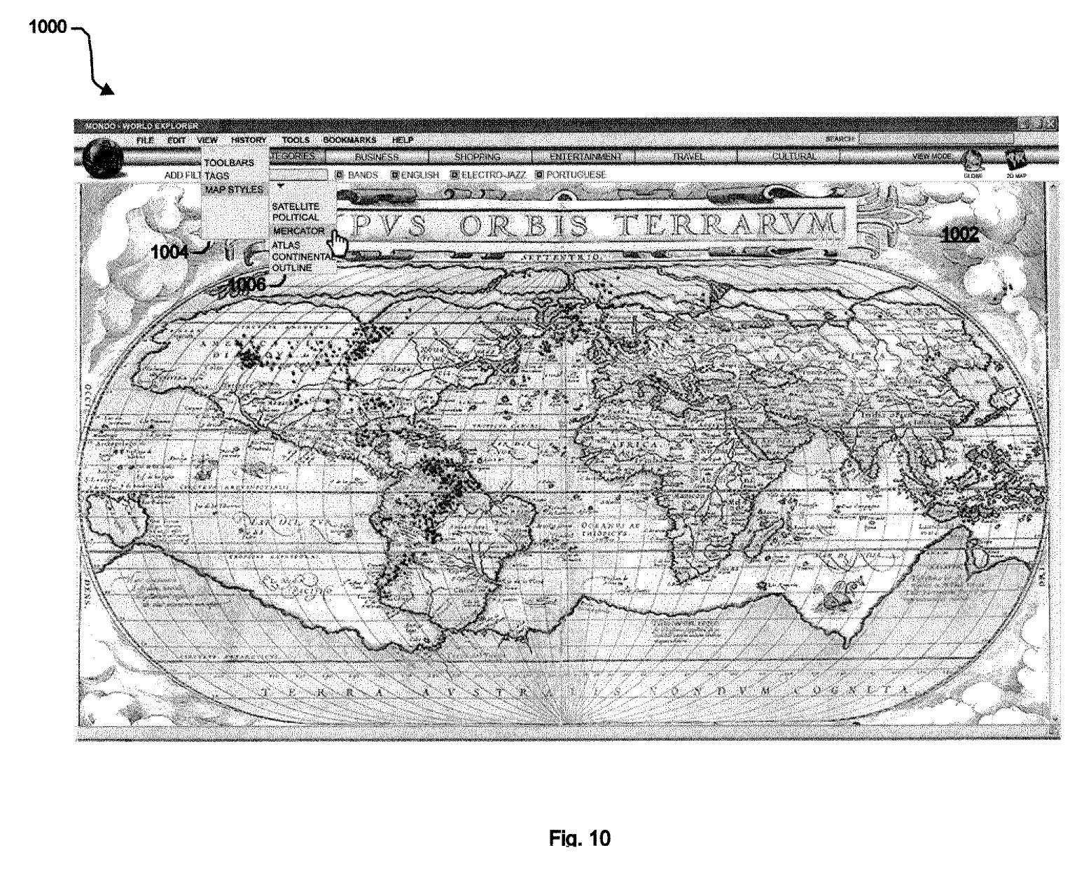

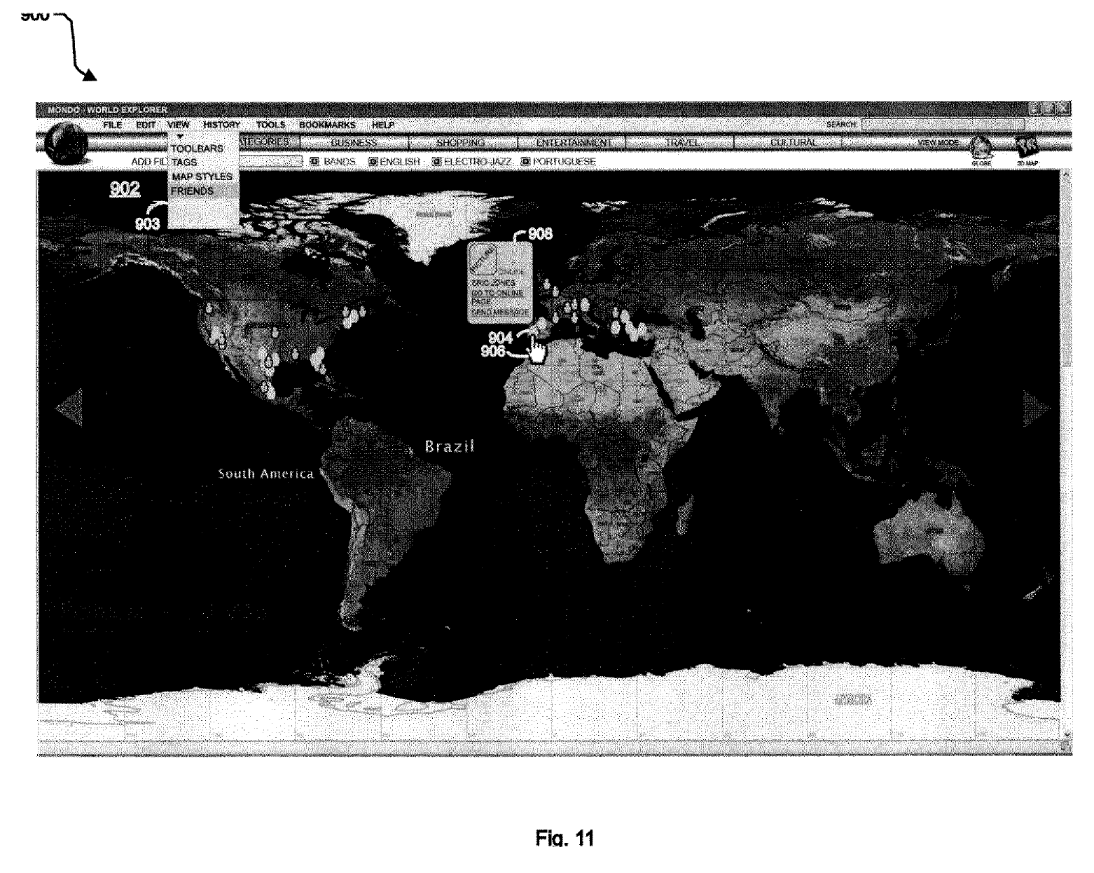

Numerous additional functions and operations may be made available. For example, a translation facility may be provided to translate the results list 222 or other information to a desired language, for example, by extracting the text from the results list, delivering the text to an online translation facility and returning the translated text to the results list in its original format. FIG. 5 illustrates the browser window 200, illustrating the map 202 showing the same view as provided by FIG. 4, but with the results list 222 translated to Portuguese, as a result of selection using the tools menu 502 and submenu 504. In addition to explicitly selecting a language using such menus, the system 110 may also provide facilities to select a translation language based on a map selection, such as by translating a mouse pointer position to geographic location information, retrieving language information for the location from the database 130, and selecting the translation language using the language for the location.

Numerous other facilities are available to manage search results and present additional information. For example, FIG. 6 illustrates the browser window 200, with the range of the map 202, further zoomed in to show a portion of the city of Brasilia, Brazil. The search results are presented on the map 202 as highlighted markers, more clearly visible because of the larger scale of the map.

Facilities may be presented to manage search results and other information using graphical inputs to indicate desired areas of interest and modes of presentation. FIG. 7 illustrates a browser window 700, showing a map 702 presenting search results restricted by a boundary 704 traced by a drawing tool 706. A results list 708 includes results limited to those within the boundary 704.

FIG. 8 illustrates a browser window 800, showing a map 802 presenting search results along a path 804 traced by a drawing tool 806. A results list 808 includes results limited to those along the path 804.

FIG. 9 illustrates a browser window 900, showing a map 902 and an information display box 904, resulting from selection of a country of interest. The selection has resulted in retrieval of geographic information from the correlation table 124 to determine the geographic location of the position on the map 902 of the highlighted area, and retrieval and display of selected information from the geographic information table 130 and its display in the box 904.

FIG. 10 illustrates an example of an alternative map style that may be used. Numerous different map styles may be used to present results. In the present example, a historical Mercator map 1002 has been presented, laid out according to the geographical knowledge that was current at the time the map was designed, with the selection having been made using the view menu 1004 and submenu 1006. The image or images used to present the map style may be stored in the interface database 123, for example, and appropriate images retrieved therefrom and used to assemble the desired view.

FIG. 11 illustrates a browser window 1100, showing a map 1102 presenting markers showing the location of a user's social networking friends. Identifying information for the contacts in the list is taken from the user information database 129, and the correlation table 124 is been used to assign geographic location information to each contact. Markers are presented for each contact, with each marker being placed on the map 102 according to the geographic location of the contact, such as the marker 1104. The mouse pointer 906 is resting on the marker 906, resulting in the display of an information box 1108 with information suitably taken from the user information database 129.

FIG. 12 illustrates the steps of a process 1200 of Internet browsing and results management according to an aspect of the present invention. The process 1200 may suitably be accomplished using a system such as the system 100 of FIG. 1. At step 1202, a browser interface is prepared and presented to a user. The browser interface may comprise elements selected to present a desired appearance to the user, and preferably includes a map for the presentation of search and navigation results based on geographic information assigned to the search and geographic results. At step 1204, in response to search or navigation inputs, one or more websites of interest are identified as search or navigation results based on those inputs and a results list is prepared. At step 1206, indicia relating to each search result is examined and used to identify a geographic location associated with the search result, and geographic location information is assigned to each search result. At step 1208, results are assembled based on user preferences and the results are presented to the user in one or more of a list or a map display. At step 1210, upon further user inputs, results meeting the changed user inputs are assembled and presented to the user.

While the present invention is disclosed in the context of a presently preferred embodiment, it will be recognized that a wide variety of implementations may be employed by persons of ordinary skill in the art consistent with the above discussion and the claims which follow below.

We claim:

1. A data processing system, comprising:
memory storing specifications for a user interface to be presented to a user, the user interface comprising facilities for receiving user inputs defining characteristics of Internet pages to be selected for presentation to the user, the facilities for receiving user inputs including facilities for designating a geographic location of interest, the facilities for designating a geographic location of interest including a graphic presentation of a map and tools to designate the geographic areas of interest on the map;
a processor for presenting a user interface according to the specifications and responding to user inputs by creating a selection of Internet pages conforming to the characteristics defined by the user inputs, creating the selection of Internet pages comprising examining geographic location information for each Internet page to be considered for selection and accepting the page for presentation if the geographic location information conforms to the user inputs, the processor creating a visual presentation of Internet pages conforming to the selection criteria, the presentation including placement of a marker for each conforming Internet page on a map display, the placement of the marker being determined by the geographic location information associated with the Internet page.

2. The data processing system of claim 1, wherein the processor performs an Internet search based on the user inputs and to create a list of search results conforming to the user inputs, and wherein the user interface is further operative to accept inputs defining a subset of search results, the inputs including entries designating boundaries of the map display so as to present search results whose geographic location is within the designated boundaries.

3. The data processing system of claim 1, wherein the processor performs an Internet search based on the user inputs and presents the search results and wherein the user interface is operative to receive further user inputs altering the geographic location of interest, the processor responding to the further user inputs by creating a new search using the geographic location information as a search term and presenting the search results conforming to the new search.

4. The data processing system of claim 3, wherein the further inputs altering the geographic location of interest include inputs zooming the map display in or out.

5. The data processing system of claim 4, wherein the further inputs altering the geographic location of interest include inputs defining boundaries within the map display, with the new geographic location of interest lying within the boundaries.

6. The data processing system of claim 1, wherein the processor assembles a results list of results of the search and responds to further inputs through the user interface by restricting the search results presented based on the further inputs, restriction of the presentation of results comprising presenting a map display showing results in a new geographic area of interest defined by the further inputs.

7. The data processing system of claim 6, wherein the user interface comprises facilities for receiving filter and preference information and wherein the filter and preference information is applied to the results list to restrict the search results.

8. The data processing system of claim 1, further comprising a user information database comprising information entries of interest to a user, and wherein the processor operates to present selected entries in the user information database according to their geographic location.

9. The data processing system of claim 1, further comprising a repository of information relating to geographic locations, and wherein the processor is operative to present selected information for a location upon placing of a pointer at a map position of the geographic location.

10. A method of Internet search, navigation, and presentation, comprising the steps of:
creating a user interface including a map display and facilities for receiving user inputs designating characteristics of Internet pages to be selected and presented;
upon receipt of user inputs defining the characteristics of the Internet pages, selecting Internet pages conforming to those characteristics and presenting a set of the selected Internet pages, presenting the set of selected Internet pages including presenting a marker for each presented Internet page, each marker being placed on the map display at a position conforming to geographic location information associated with the Internet page.

11. The method of claim 10, wherein the user inputs include graphical selections defining a geographic area of interest and wherein selection and presentation includes selecting and presenting results conforming to the geographic area of interest.

12. The method of claim 11, comprising receiving further user inputs after presenting results, the further user inputs including making graphical selections redefining the area of interest, and wherein selection and presentation includes changing the presented results to conform to the new area of interest.

13. The method of claim 13, wherein making graphical selections includes redrawing boundaries defining an area of interest.

14. The method of claim 10, wherein making graphical selections includes defining a line between points and presentation includes presenting results within a predefined distance from the line.

15. The method of claim 10, further comprising translating pointer position information to geographic location information based on a pointer's position on a map display retrieving information relating to a geographic location upon positioning of a pointer at a map position of the geographic location.

16. The method of claim 10, further comprising storing a repository of information of interest to a user in association with geographic location information associated with each element of the repository, and presenting the information in a map display.

17. The method of claim 10, further comprising associating an operation with a geographic location of interest and performing an operation associated with a geographic location based on selection of the location.

18. The method of claim 17, wherein the operation comprises translating presented information to the local language of the location of interest.
